(19) United States
(12) Patent Application Publication
(10) Pub. No.: US 2007/0210934 A1
(43) Pub. Date: Sep. 13, 2007

(54) Double barrel chemical seeking sidewinder gun devices

(76) Inventor: Marrell Haney, Chicago, IL (US)

Correspondence Address: Marrell Haney, 1301 West 96th Street, Chicago, IL, 60643, US

(21) Appl. No.: 11/518,376

(22) Filed: Sep. 7, 2006

Related U.S. Application Data
(62) Division of application No. 11/122,307, filed on May 4, 2005, now Pat. No. 7,187,300.
(60) Provisional application No. 60/567,305, filed on May 4, 2004.

(51) Int. Cl. G08G 1/095

(52) U.S. Cl. 340/907

(57) ABSTRACT

A large size vandal and weather resistance sign, capable of displaying images from several components, including a video cassette with tapes or video disc and other component parts for broadcasting command directions and to provide information. The sign system, with a front and back side and a left and a right side is securely enclosed with a top side and a bottom side. The frame's materials include aluminum steel and vandal resisting and weather resisting plastics for the left and right sides and plastic sheet coverings for the for the front and back side door panels. In the event of a power outage, batteries ensures a power source for the system: it also remain constant in providing power for the sidewinder gun devices, sensors, receivers, timers and other devices, that include surveillance camera, transmitters and relay devices. The large size sign system is adapted for mounting to utility poles, or by installing a main pole near an intersection that pivots vertically to a desired point or a height required by code regulations. A second pole is provided for pivoting horizontally to the center most part of the street as a source for attaching the main security system. There are spring-like motion and shock resistance devices having designs that will provide added protection for the security system during severe wind storms.

### This application claims priority of Provisional Application

APPL: 60/567,305
Filed: May 4, 2004

Prior Publication Data

| Int.Cl: | A47G,33/04 |
|---|---|
| U.S.Cl: | 445/22,428/7,11,40/594,564,584,340/04,D20/10 |
| Fielf of Search | 428/11,187,40/584,248/223,41,D20/10,29 |
| | 340/901,445/22,40/538 |

Prior Arts

U.S. Patent Documents

| | | | |
|---|---|---|---|
| 1,368,144A | 2/1921 | Haughwout | |
| 1,994,937A | 3/1935 | Berger | 40/612 |
| D,161,150 | 12/1950 | Burro | |
| 2,823,475 | 2/1958 | Packard | |
| 2,046,044 A | 6/1936 | Vissing | |
| 2,080,679 A | 5/1937 | Vissing | |
| 3,590,508 | 7/1971 | Jones et.al | 40/573 |
| 4,108,405 A | 8/1978 | Gibson | 40/902 |
| 6,522,263 B2 | 2/2003 | Jones | |
| 6,607,412 B2 | 8/2003 | Mueller, et.al | |

Foreign Arts

| | | |
|---|---|---|
| 450,602 | 7/1936 | United Kingdom |
| 1,375,813 | 11/1974 | United Kingdom |

### BACKGROUND OF THE INVENTION

1. Field of the Invention

The present invention relates to an exterior school crossing guard, security system that can be mounted on a pole combination that is installed in the center of the street, or near the sidewalk, a pole may be installed by pivoting upward to code specifications and a second pole that pivots inward to the center of the street where the system is installed. The multipurpose security system is preferably suited to aid or alleviate the need for crossing guards and other security personnel in the supervision of pedestrian and vehicular traffic. In addition, the present invention offers innovations for our security and education planners, who must use new methods for serving and protecting the citizens of their cities and states. In the mean time, the present invention with its video cassette, audio and video images and a highly specialized system of integrated sensors, receivers and timing devices that are suitable for sniffing substance of dangerous gases, and detecting other dangerous chemicals, will aid in the prevention of explosive materials in close proximity of schools and other public facilities and providing huge saving for municipalities throughout the world.

### SUMMARY OF THE INVENTION

Accordingly, an object of the present invention is to provide an apparatus and methods for improving security at schools and other public and private facilities. The multipurpose sign security system is preferably installed onto special, or utility poles in close proximity to large facilities and near intersections.

Another object of the present invention is to preferably installed chemical detecting sidewinders guns which are also detachable, and suited for use in cars and other locations.

A further object is to construct the sign system with materials, such as flat aluminum metal bars approximately 2 inches wide for the left and right borders; and aluminum, flat L-shaped corner bars with grooves that are suitable for inserting the sheets of vandal resistance plastics at each border of the sign. The sign system is preferably 4 feet high, 2 feet wide and the front and back plastic sheet-covers encased at each frame border with thin aluminum metal (flat) bars that are suitable for attaching small metal hinges for each door.

The corner bars may require welding as a way of joining the corner and side bars. Means of egress for each side of the unit can also be achieved by using the hinged method. Aluminum steel or plastics are suitable materials for the top and bottom sections of the unit. A variation of sizes and dimensions are suited for compliance in meeting some municipal code specifications. Accordingly, suitable materials for the construction of the frame will consist of 4 flat preferably grooves-type metal bars, approximately 2 inches wide with 4 flat metal bars being about 1 inch wide to be used as, approximately, four feet long horizontal bars and 4 vertical bars being approximately 1 inch wide and 4 horizontal bars being approximate 1 inch wide that are suitable border fasteners in the event that grooved bars are not used. Additional materials such as locking devices, screens door hinges and sealer substance materials to prevent corrosion inside of the system.

The other component to the present invention are two smaller version of the larger model, which are preferably installed on stop and go light poles. A combination of two metal poles that are preferably installed at curbsides with the base pole pivoting upward to about 20 feet; and a second pole that pivots inward to the center of the street, to be used as a retainer unit for the security system. Some component parts to be installed in the system are; surveillance and video cameras, Screen units, speakers, receivers, timers, relays, transmitters, video, video-cassette and rechargeable batteries to be used as a second power source during electrical power failures. The video devices are preferably suited for broadcasting directions, messages and information to motorists, pedestrians and Central Station where transmitted data are tested and analysed.

The pole models are preferably constructed of aluminum steel (flat) bar panels, each having approximately 12 inches in width with a left and right metal frame border line or side bars that are perpendicular to the upper most part of the unit. Each flat bar is preferably designed with 1 inch grooves capable of allowing for the retaining of approximately ½ inch vandal strength plastics. Another method of securing the plastic door covers is by using materials such as thin metal plates and tamper proof metal screws. Finally, the third component of the security system is a central station where programming of data receiving data, analyzing it and making decisions including the gathering of information and keeping records of all occurrences.

The fourth component of the security system are the chemical seeking sidewinder guns. These devices that are equipped with an integrated array of devices such as high-tech sensors, receivers, transmitters, indicator and relay devices; along with switches and detectors, such as scanners and x-ray devices, are preferably suited for detecting, isolating and providing an accurate identification of a targeted substance.

### BRIEF DESCRIPTION OF THE DRAWINGS

FIG. 1 is a perspective view of a weather and vandal resistance security system, having a front and back side and a top and bottom side. The sign unit is preferably constructed of vandal resistance plastics and aluminum metals.

FIG. 2 is an exploded view of the school crossing guard, security system, showing a rotating dome light at the top. The chemical seeking sidewinder guns being attached near the bottom section of the system, functionable parts, have electricity as their first power and electric charged batteries as the second power source to be used during electric power failures.

FIG. 3 shows a perspective view of two pole models of the school crossing guard, security system and also equipped with audio, cameras and video cassette and switches, timing devices with a complete package of component parts.

FIG. 4 is a perspective view showing a pair of chemical seeking sidewinder guns that are suitable for detecting and identifying dangerous substances that could be used for explosive such as bomb making materials.

FIG. 5 is a perspective view showing a plurality of metal brackets and clamping devices that are preferably suited for attaching the pole model security system to utility poles, including stop and go light poles.

FIG. 6 is a schematic perspective view of numerous electrical devices that suited for usage in an integrated system for the detection, receiving, and transmitting data to central station where the data is identified and official decisions are made.

FIG. 7 is a perspective of a time line incorporated into a cluster chain of events that are preferably used in the prevention of car bombing and other terrorist acts.

### DETAILED DESCRIPTION OF THE DRAWINGS

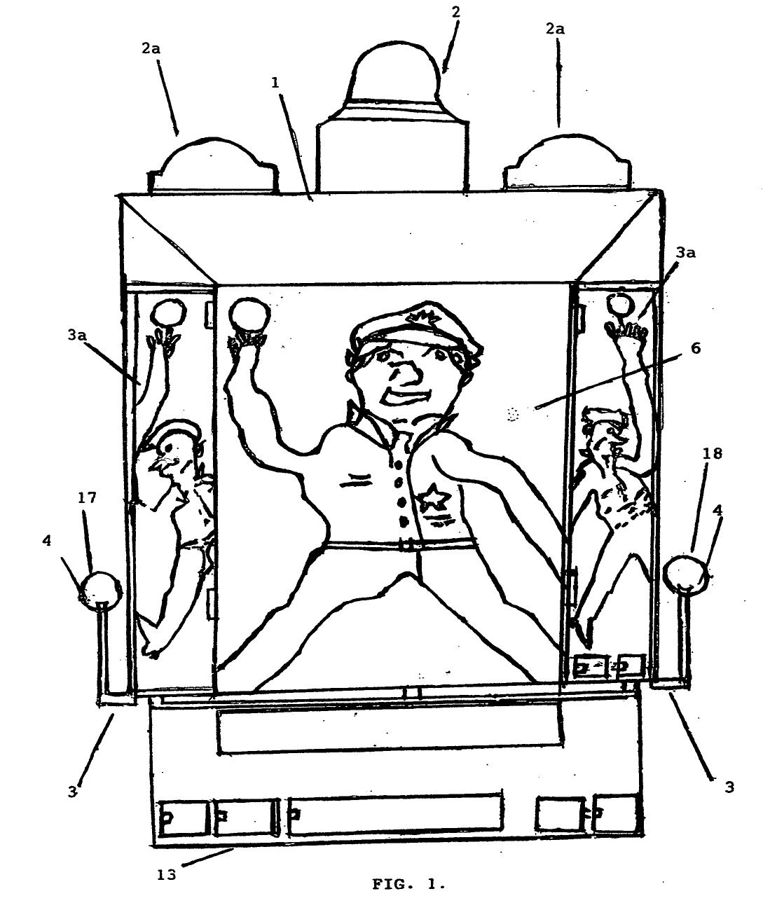

Referring now to the drawings, there is shown a school guard security system generally included at 1 indicating the features of the present invention in preferred drawings in which a box-like sign system FIG. 1 is provided with a front side view and a back side view and included is a left side view and a right side view. The school crossing guard, security system 1 which comprises aluminum steel, fiberglass, plastic materials, can be assembled through a process of welding, molding, metal screws, bolts and like for joining together the frame's horizontal and vertical bars including brackets, cross bars and corner bars. Operational component parts and devices include sealers, electricity, rechargeable batteries, transformers, and the like, for the present invention.

Referring to the drawings, FIG. 1 is a perspective view of the present invention; and depicted in windows 3a are left and right side views of video images of security guards provided in 6 on the front side and 6a (not shown) on the back sides are identical video images of security guards. The use of video cassette having timers, switch and the like are required. Provided in the invention 1 of FIG. 1 are video/audio messages including information and directions for motorists and pedestrians. Due to certain guidelines of municipalities including code specifications, the size and dimensions of the system is adapted to meet compliances. But in general, the system should have a preferred measurement of 5 feet in width 4 feet in height and 3 feet deep measurement from the front side to the back side of the cabinet. The construction of of the frame should consist of 4 horizontal cross bars of a flat composition being approximately 3 feet long, 4 vertical corner bars with measurement of approximately 4 feet. All bars should have a preferred measurement of 2 inches in width. The bars should have a diameter measurement that is suitable to accommodate sheets of vandal resisting plastics and the like. Each frame bar must be designed with in-lay grooves that provide enough space for inserting plastic window cover sheets. Corner brackets, facings, sealants and the like are to be used for neither proofing and for frame reinforcement.

Metal hinges being approximately 3 inches wide are preferred for joining the several doors. The doors should open perpendicular to a level plane in order to provide a work area for occasional repairs. Plastic rotary dome lights 2 and 2a are adapted to be programmed by timing devices on an intermitting schedule and during emergency occurrences. The dome-lights having aluminum or plastic bottoms may be enclosed with a preferred metal ring around the base. Dome lights 2a are adapted to blink as the center rotary light 2 rotates. Similarly, the lights 17 on the left side and 18 on the right side, are adapted to revolve as they blink; each being activated by timing devices. The lights 17 and 18 are erected on 1 inch, round rods that pivot 12 inches vertically from their base. Each rod having electric wirings that is threaded through extension bars that are about 12 inches from the exterior base which is on each side of the lower cabinet, and threaded upward through rod 3 and on to light fixture 4. Again, materials suitable for use in building the main unit 1 and pole models 32, are aluminum steel, plastic, metal screws and metal nuts. Also, welding and molding are processes that may be utilized as a way of connecting parts together.

The lower cabinet 13 having a width of approximately 7 feet and a height of approximately 1 feet and including a depth of 3 feet is adapted for housing most devices including switches, relays, timers, batteries and other devices. The lower cabinet having an aluminum door that is joined to the cabinet with metal hinges is adapted to open perpendicularly to a level plane; thereby, providing an occasional work area. Materials for framing and enclosing the the lower cabinet are preferably 4 flat horizontal bars being approximately 5 feet long and 4 vertical corner flat bars being approximately 1½ feet long and 4 flat horizontal cross bars with measurements of approximately 3 feet long. Two aluminum sheets measuring 1½ feet by 5 feet are preferably used for enclosing the front side and the back side of lower cabinet 13.

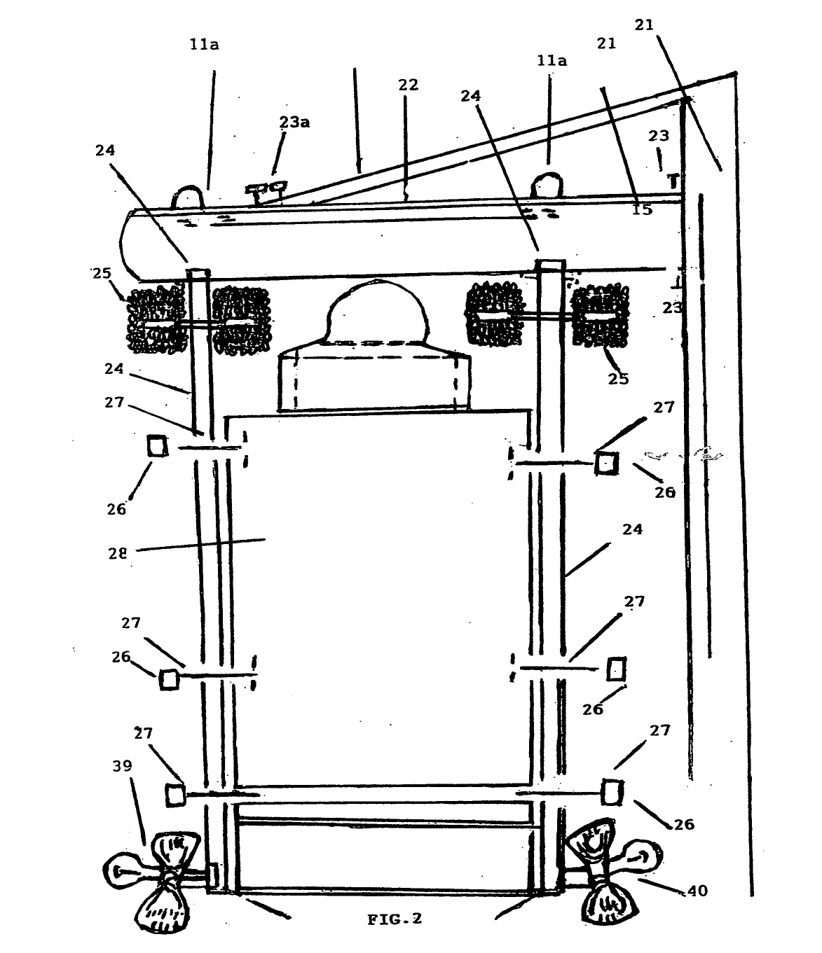

FIG. 2 is a perspective showing a metal pole combination 21 and 22. Pole 21 should pivot, vertically to approximately 18 feet and having a horizontal extension pole 22 for retaining invention 1. There are two aluminum steel bars 24 being diametrically the same, and having a width and thickness of approximately 2 inches for frame bars and intended for securing system 1 with metal bolts 27, and metal nuts 26. Lower cabinet 13 is adapted with shock absorber devices 25 which can provide addition protection for the main system 1 during severe wind storms with mechanisms adapted for stopping the system on a horizontal plane, as viewed from the point of extension/retainer pole attachments 11a, and thereby providing a lesser direct impact from violent winds. Pole 21 can be installed near an intersection between sidewalks and curbs; it height, 18 feet, connects to retainer pole 22 with metal bolts and clamps devices. Connecting the main vertical pole 21 to retainer pole 22 is achieved at section 23 with clamps and bracket devices; a support bar 48 attaches to retainer pole 22 at section 23a. The sidewinder gun devices 39 and 40 are adapted for attaching to lower cabinet 50 with an assortment of devices including metal nuts and bolts.

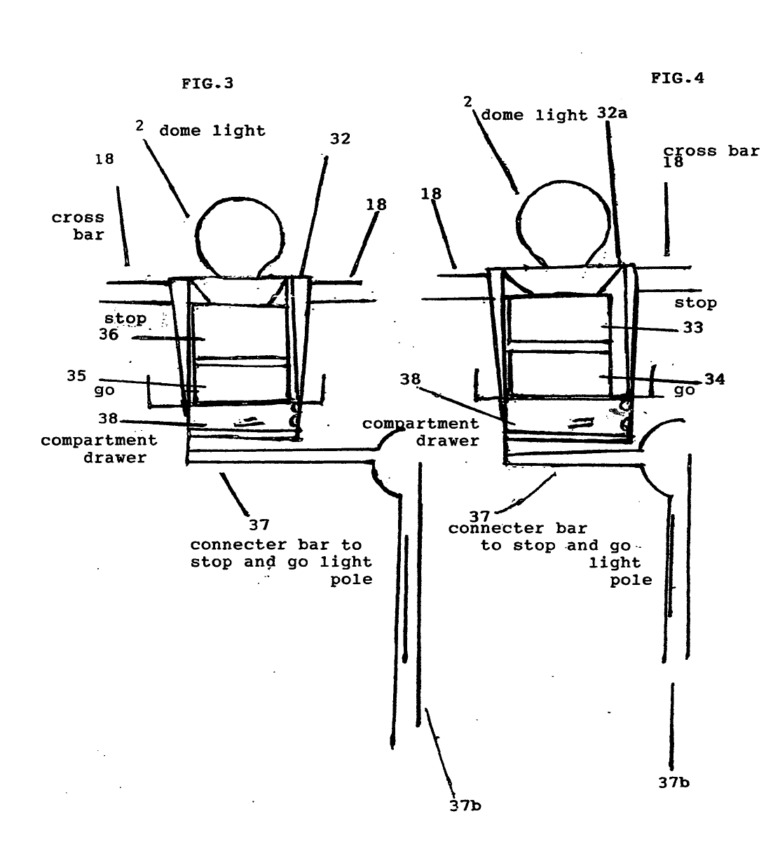

Referring to FIG. 3 is a pole model, crossing guard security system, having specialized functions. Pole model FIG. 3 is adapted for utility pole including stop and go light poles; it can be programmed to function in tandem with main school guard security system 1 or or other planned schedules. Materials suitable for building the pole model can consist of aluminum steel, plastics, tamper proof 1½ inches metal screws or welding for joining together the frame. Metal clamps 29, FIGS. 8 and 9, are suitable for connecting pole model with clamps at section 37 a cross bar device being suited for utility pole connections, by wrapping clamping device around utility poles. Pole model 32 of FIG. 3 in accordance to the present invention is providing with a rotary/blinking dome light 2, stop light 35, a go light 36 and video information in side bars 18. A utility drawer havroller 38. The utility compartment is provided with space for batteries, switches, relays, transformers and other devices. A variety of metal clamps are suited for connecting the system 32, FIG. 3 to utility poles. A video cassette is also provided with other devices including sensors, transmitter and receivers.

Referring to FIG. 4 is a pole model school crossing guard, security system, having identical functions, parts and devices as 32 of FIG. 3, However, pole model 32a in FIG. 4 is also provided with a stop light 34, a go light 33, a rotary dome light 2a and cross bars 18a which are adapted for video messages. The drawer compartment 38a is a slide out component having rollers, can accommodate batteries, timers, transformer, relay switches and other component devices. The pole model 32a of FIG. 4 suitable for connecting to utility poles with metal clamps and other devices. Both pole models 32 of FIG. 3 and pole model 32a of FIG. 4. Materials suitable to build, both pole model security systems 32 in FIG. 3 and 32a in FIG. 4, are aluminum steel flat 1½ inches in-lay bars for inserting and retaining aluminum sheets or the doors sheets may be joined to the frame with metal hinges. Four flat frame bars at approximately 18 inches in length with thickness of about ½ of an inch and measuring 1½ inches in width. Horizontal bars being about ½ of an inch thick and 1½ inches wide should be approximately 18 inches in length to be used for framing parts for both pole model systems 32 of FIG. 3 and pole model system 32a of FIG. 4.

The drawer compartments as seen 32 of FIG. 3 and 32a of FIG. 4 are suitable for housing parts and devices including batteries, timers, cameras and sensors. Metal screws and metal nuts or welding are suitable ways to join together various parts for the pole model systems. Cross bars 18 of FIG. 3 and 18a of FIG. should pivot about 12 inches horizontally from the frames of FIGS. 32 of FIG. 3 and 32a of FIG. 4. Cross bars 32 and 32a are adapted for bars designs that are suitable for video cassette messages.

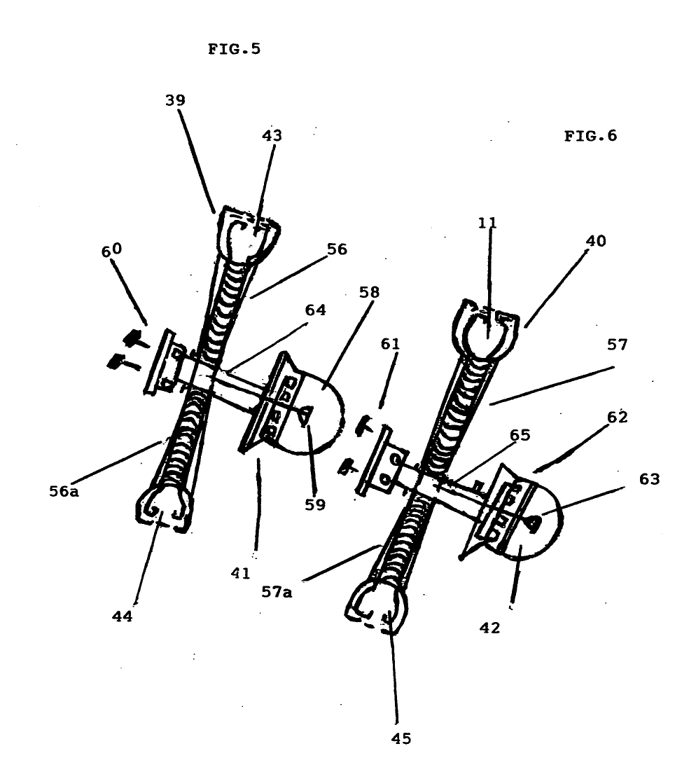

Referring to FIG. 5 is a perspective of a sidewinder gun device 39 having mechanisms that provide for the detecting of certain dangerous chemical through a system of integrated devices including sniffers, highly specialized sensors. These detectors within the sidewinder guns 39 and 40 of FIGS. 5 and 6 are are suitable for detecting and selecting substances for further scientific analysis which is determining at a central station 4. The main power source for the double barrel chemical seeking sidewinder gun device 39 is provided from electricity. However, the gun device 39 is also functionable when receiving power from batteries. Although the sidewinder gun devices are a major component for the main school crossing guard, security system, it is designed to function in a detachable mode.

Whenever the sidewinders detect data which indicates substances that can be used to make explosive devices similar to bombs, they are transmitted by an operator to the technicians at central station FIG. 12 for official determinations; and action are taken. The sidewinder gun 39 connects to the main invention 1 onto bottom frame bars 24 at the left side 50 of FIG. 2 and the right side 50a of FIG. 2. Each device is adapted to snap into metal brackets that extends out on each side of the system.

Referring to FIG. 6 is a perspective of a double barrel sidewinder gun device 40 which is identical to the sidewinder gun device 39 in FIG. 5 and it has the same functions that are provided in Sidewinder gun device 39. The double barrel features 57 and 57a FIG. 6 are intake tubes adapted for receiving gases being detected from sniff devices 11 and 45 a process that is

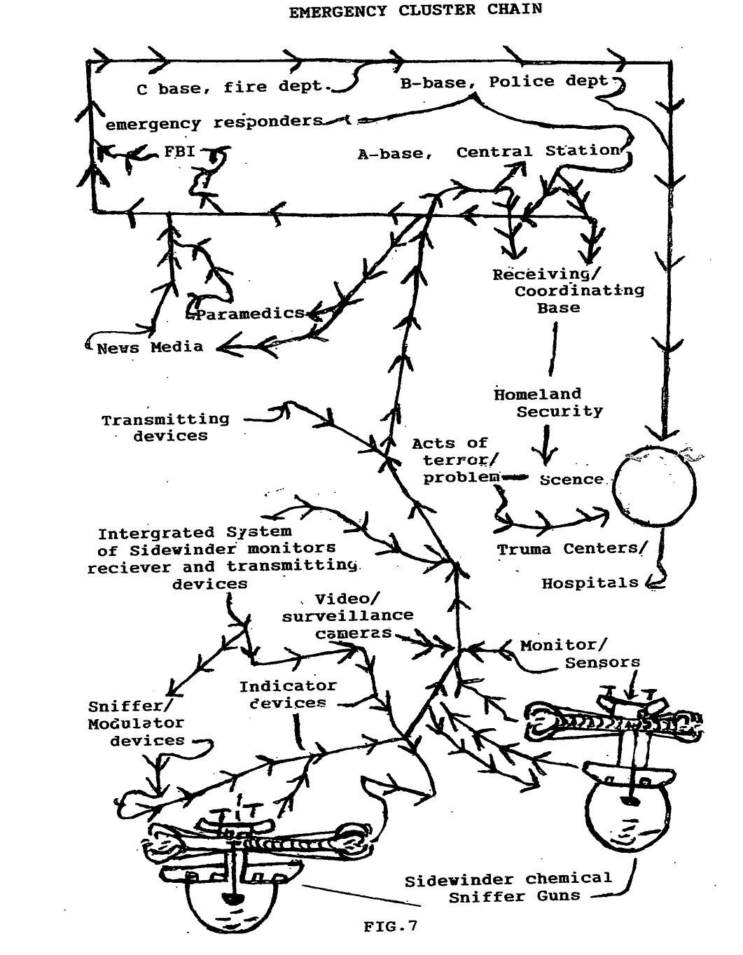

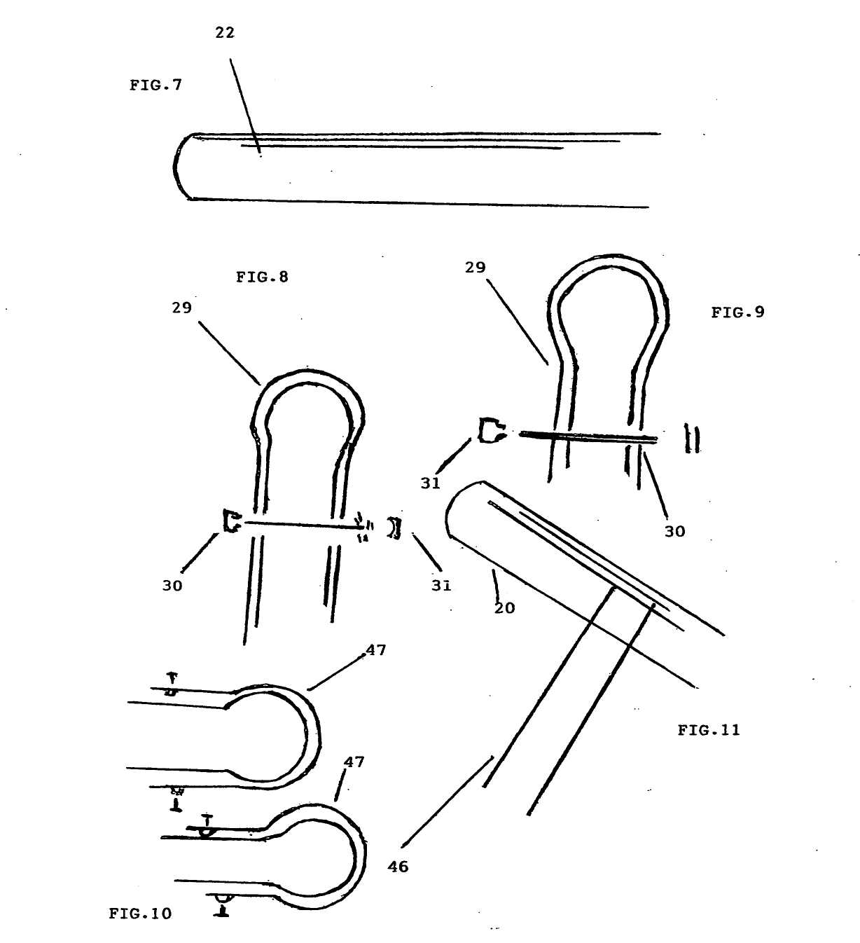

Referring to FIG. 7 is a perspective view of a retainer pole 22 which may be used as an extended component to metal pole 21 FIG. 2 as a source for installing invention 1.

Referring to 29 seen in FIGS. 8 and FIG. 9 are metal clamping devices that are suitable for securing pole models, 32 and 32a, FIGS. 3 and 4 to utility poles, with nuts 30 and bolts 31 as seen in FIGS. 8 and 9.

Referring to FIG. 10 are metal clamps 47 being a smaller version are also suitable for use in securing pole model security systems to various utility poles.

Referring to FIG. 11 is a perspective view of a curbside pole 46 having a component pole 20. Metal pole 46 is a vertical design that may be installed near curbside and pivot up to a desired point to be connected to retainer 20 which is adapted, to pivot horizontally to a desired location as a device for installing pole models FIG. 3 and FIG. 4; or for installing a smaller side main security system 1.

Referring to FIG. 12 is a schematic drawing of an imaginary plan that follows a pattern of action base on emergencies that are, or may occur following detection or detonating of explosive devices including bombs. Materials that are preferably used to build the double barrel chemical detecting sidewinder gun devices are metal and plastics; parts should include sealants, metal and plastic tubings for sections 11, 43, 44, and 45 in FIG. 5 and FIG. 6.

Referring to FIGS. 5 and 6 are double barrels chemical detecting

What is claimed is:

1. A school crossing guard, security system comprising:
a security display sign device designed to be viewed by pedestrians and motorists;
a aluminum sign having four transparent sides and provides video messages, prepared by security planners;
a security sign device having revolving lights and is mounted at the center of intersection areas;
a revolving light combination having blinkers on vertical side bars which are located at the lower exterior of the system;
a aluminum steel frame retainer, adapted for mounting onto a retaining pole having adaption for horizontal use, for protecting the main invention; and
a metal frame cabinet retainer device having shock resisting and stopping guides designed to control the security sign by stopping it at a horizontal plane from the base of the sign's cabinet during violent wind storms.

2. A school crossing guard, security system comprising:
a pole model security component having a revolving light at its exterior top side designed with a blinker device;
a front view and a back view having a design for stop and go lights at the center sections of the system;
a cross bar device designed for video messages as seen on a horizontal line;
a lower compartment drawer for switches and other devices.
a device having sensors integrated components that will provide detections and identification of dangerous substances in an interior and exterior environment;
a device having indicator, transmitter, receiver, and integrated component devices that provide for collection of specified samples of explosive substances;
a device equipped with sensors that activate an alarm trigger device upon detection of substances that have additives capable of being used bombs.

4. A double barrels chemical seeking sidewinder gun devices comprising:
an integration of high-tech sensors that will detect and isolate poison gas in an interior and exterior environment; and
an analytical device having receivers, indicators and transmitters that functions as intake and desimilar of gas substances as the various gases enter into the analytical device upon detections by the integrated sensor components.

5. Double barrels chemical seeking sidewinder gun devices according to claim 1 comprising:
a relay device that is activated by a digital computer to transmit data that is coded with dangerous readings of chemical materials to a central station for indebted examinations by trained professionals in the field of chemical warfare; and
a sensor mechanism that is adapted to monitor all component devices and activate switches for emergency signals and transmissions of component units.

6. Double barrels chemical seeking sidewinder gun devices according to claim 1 comprising:
a sensor detecting device comprising double barrels with interior pores that are located in intake passages where chemical substances are transferred to the analytical devices; and
a schematic plan for emergency responders and security professionals to follow upon detecting and recording dangerous measurements of poison gas.
